(19) United States
(12) Patent Application Publication
(10) Pub. No.: US 2026/0253135 A1
(43) Pub. Date: Aug. 27, 2026

(54) REAL-TIME FRAUD DETECTION SYSTEM USING DENDRITIC MEMORY MODELING AND QUANTUM INTEGRATION

(71) Applicants: SHUBHAM CHANDRA, Katy, TX (US); Ravi Kiran Bhaskar, Centreville, VA (US); Sharad Baranwal, Oak Hill, VA (US)

(72) Inventors: SHUBHAM CHANDRA, Katy, TX (US); Ravi Kiran Bhaskar, Centreville, VA (US); Sharad Baranwal, Oak Hill, VA (US)

(21) Appl. No.: 19/183,208

(22) Filed: Apr. 18, 2025

Related U.S. Application Data
(63) Continuation-in-part of application No. 19/060,681, filed on Feb. 22, 2025.

(51) Int. Cl. G06Q 40/02

(52) U.S. Cl. CPC G06Q 40/024

(57) ABSTRACT

A real-time fraud detection system is disclosed that models financial transactions as evolving memory graphs using biologically inspired dendritic architectures. The system employs graph neural networks with edge decay and reinforcement mechanisms to retain behavioral context over time, enabling dynamic anomaly detection. An attention-based recall module reactivates latent fraud patterns based on contextual similarity. Optionally, quantum walk engines and entangled memory states are integrated to accelerate pattern discovery in high-dimensional data. The invention supports few-shot meta-learning, real-time inference, and deployment on neuromorphic or quantum-classical platforms, offering adaptive, scalable, and interpretable fraud detection across dynamic financial ecosystems.

### CROSS REFERENCE TO RELATED APPLICATIONS

This application is a Continuation-In-Part (CIP) of U.S. application Ser. No. 19/060,681, filed on Feb. 22, 2025. The present application contains subject matter not disclosed in the parent application, specifically introducing a novel integration of dendritic memory modeling and quantum computational techniques for real-time fraud detection in financial systems.

### FIELD OF THE INVENTION

This invention pertains to the domain of financial cybersecurity and fraud detection, focusing on the application of artificial intelligence, neuromorphic computing, and graph-based deep learning models. Specifically, it introduces a real-time anomaly detection framework for dynamic financial transaction networks, utilizing a biologically inspired neural architecture that emulates dendritic memory processing observed in mammalian brains. The system constructs temporally and contextually linked memory graphs, where nodes represent financial events (e.g., transactions, user activities) and edges encode associative strengths based on temporal proximity, behavioral patterns, and interaction frequency. These graphs are processed using graph neural networks (GNNs) with adaptive attention mechanisms and dendritic subunit emulation, enabling context-aware detection of fraudulent or anomalous behavior. Unlike traditional rule-based or heuristic systems, this model continuously learns from evolving transaction patterns through localized synaptic plasticity analogs, adjusting connection weights based on input salience, spike-timing correlations, and user-specific behavioral contexts. The invention also optionally integrates quantum computational modules, such as quantum walk engines and entangled memory registers, to enable parallel exploration of probabilistic fraud pathways across high-dimensional transaction data, significantly enhancing detection speed, robustness, and adaptability. By combining dendritic spiking-inspired processing, graph-based contextual reasoning, and quantum-compatible structures, the system delivers an efficient, explainable, and scalable solution for proactive fraud detection across banks, fintech platforms, blockchain environments, and decentralized financial systems.

### BACKGROUND OF THE INVENTION

Financial institutions, payment processors, and digital transaction platforms face an escalating threat landscape characterized by sophisticated, adaptive, and distributed fraud strategies. These fraudulent activities evolve rapidly, exploit diverse vulnerabilities, and cause billions of dollars in annual losses across global financial ecosystems. Traditional and modern fraud detection systems, while attempting to mitigate these risks, suffer from several structural and operational limitations that hinder their effectiveness in real-time scenarios.
(a) Static Detection Heuristics: Legacy systems often rely on predefined rule sets, such as transaction amount thresholds, IP address filtering, or geographic blacklisting, which require manual updates to address emerging threats. This reactive approach introduces significant delays in threat response and is easily bypassed by novel fraud patterns.
(b) Machine Learning Model Degradation: Supervised machine learning models, while improving upon static rules, require frequent retraining to maintain effectiveness. Without timely labeled data or in the presence of concept drift (e.g., changing transaction behaviors), their performance degrades rapidly, necessitating resource-intensive retraining that introduces operational downtime and fails to keep pace with evolving fraud tactics.
(c) Lack of Long-Term Behavioral Context: Existing systems often treat transactions as isolated events or analyze them within short-term windows, failing to capture long-range behavioral patterns—such as subtle shifts in device usage, merchant preferences, or spending rhythms—that may indicate slow-developing fraud schemes. This lack of temporal and contextual retention limits their ability to detect nuanced, temporally dispersed anomalies.
(d) High Latency in Processing Pipelines: Many AI-based fraud detection frameworks rely on centralized data ingestion, batch processing, and external model scoring, resulting in latency that prevents real-time intervention. This is particularly problematic for applications like mobile banking, cross-border payments, or decentralized platforms where immediate action is critical to prevent financial loss.
(e) Limited Scalability for High-Volume Streams: As transaction networks scale to handle billions of operations daily, conventional models struggle to maintain accuracy and performance under high-throughput, low-latency requirements. Systems designed for smaller or static datasets are ill-suited for live, graph-like transaction flows with multi-dimensional features.

In contrast, biological memory systems, particularly those leveraging dendritic structures in the brain, exhibit remarkable efficiency in real-time pattern detection, filtering, and contextualization. Dendritic neurons act as specialized computational units, performing localized input integration, temporal filtering, and context-based plasticity without centralized oversight. These systems excel at selectively retaining high-value information, decaying irrelevant memory traces, and reactivating related memories based on contextual similarity or temporal proximity. Inspired by these mechanisms, this invention introduces a computational framework that emulates dendritic memory processing for financial fraud detection. It leverages graph-based neural architectures, temporally weighted memory encoding, and local plasticity mechanisms to form dynamic transaction memory graphs that retain long-term behavioral context and adapt over time. Additionally, the optional integration of quantum computational techniques enhances probabilistic pattern detection, parallel memory traversal, and adversarial behavior modeling, addressing the scalability and latency challenges of existing systems. This biologically grounded approach represents a paradigm shift in how financial systems can model, monitor, and mitigate fraud in complex, high-speed transaction ecosystems.

### PRIOR ART REVIEW AND COMPARATIVE LANDSCAPE

Existing cybersecurity and fraud detection approaches in financial systems encompass a variety of rule-based and algorithmic techniques, each with notable limitations in adaptability, context retention, and scalability. Traditional rule-based systems, widely deployed, rely on static, human-defined thresholds or heuristic signatures to flag suspicious activities, such as hard-coded transaction limits, geolocation blacklists, and device fingerprinting. While interpretable, these systems lack adaptability and are easily evaded by evolving fraud strategies. More advanced methods employ supervised machine learning algorithms like XGBoost, Random Forests, and Support Vector Machines (SVMs), trained on historical labeled datasets. These models generalize from prior examples but require frequent retraining to address concept drift or new attack vectors, and they often operate on flattened feature vectors, discarding the temporal and relational dynamics inherent in transaction networks. Temporal modeling techniques, such as Recurrent Neural Networks (RNNs) and Long Short-Term Memory (LSTM) architectures, attempt to capture sequential dependencies in user behavior. However, they treat sequences linearly, lack mechanisms for non-linear memory reactivation, and struggle with scalability across billions of transactions due to issues like vanishing gradients. Basic graph-based methods model relationships between entities (e.g., users, devices, merchants) using link analysis or community detection but often lack temporal dynamics, dendritic-like hierarchy, or context-based memory decay, limiting their responsiveness to evolving fraud chains. Anomaly detection techniques, such as unsupervised outlier detection, autoencoders, and statistical profiling, identify deviations from normal behavior but often produce high false-positive rates and lack interpretability due to the absence of rich temporal or contextual embedding. Notably, no existing frameworks incorporate biologically inspired constructs like dendritic memory processing, spike-timed activity, or edge-weight decay to simulate natural forgetting and relevance-based memory reinforcement. Furthermore, no known systems or patents propose the integration of quantum computing components, such as quantum walk engines or entangled memory clusters, to accelerate graph traversal, detect probabilistic fraud patterns, or enhance learning from high-dimensional transaction networks. This invention addresses these gaps by combining neuromorphic principles, real-time spiking behavior, temporal edge decay, and graph-based memory linking in a scalable architecture that optionally incorporates quantum logic, creating a system that models transaction behavior with greater biological realism while supporting continual learning and real-time fraud detection across massive, evolving financial data streams.

TABLE 1
Comparative Summary of Prior Art vs. Present Invention

| Technology/ | | | Improvement Offered by |
|---|---|---|---|
| Approach | Core Features | Limitations | Present Invention |
| Rules-Based Systems | Predefined thresholds | Rigid, easily evaded, | Dynamic, self-adapting |
| | and static rules | high false positives | memory with relevance- |
| | | | based decay |
| XGBoost/Random | Supervised | Requires retraining, | Unsupervised memory |
| Forest/SVM | classification on | lacks relational | graph encoding with |
| | labeled features | modeling | adaptive learning |
| RNN/LSTM | Sequence modeling | Limited to linear time | Dendritic temporal |
| | for behavior | series, no memory | clustering with attention- |
| | prediction | reactivation | based reactivation |
| Graph-Based | Account linkage, | Lacks time sensitivity, | Temporal graph evolution |
| Methods (Static) | community | no decay modeling | with biologically inspired |
| | detection | | edge decay |
| Anomaly Detection | Identifies rare events | High false positives, no | Context-aware detection |
| (Outliers/ | based on distribution | interpretability | with dendritic |
| Autoencoders) | | | interpretability |
| Transformer-Based | Attention-based | High computational | Lightweight, biologically |
| Models (Emerging) | modeling of | cost, lacks memory | plausible attention with |
| | sequences | decay | decay |
| Quantum-Inspired | Not applicable | No integration of | Quantum walk-based graph |
| Fraud Detection | | quantum state traversal | traversal and entangled |
| | | | memory recall |

### SUMMARY OF THE INVENTION

The present invention discloses an adaptive, biologically inspired memory framework for real-time fraud detection in financial and transactional systems, named Invention: REAL-TIME FRAUD DETECTION SYSTEM USING DENDRITIC MEMORY MODELING AND QUANTUM INTEGRATION. It introduces a novel computational architecture that emulates human-like memory processes-context-based recall, temporal association, and relevance-driven forgetting-within a scalable graph neural network framework. The system is designed to detect anomalous and fraudulent behavior dynamically and efficiently, eliminating the need for constant retraining or manual rule updates. Key components include:
(a) A graph-based transaction encoding system, where financial transactions, accounts, devices, or user entities are modeled as nodes in a temporally evolving memory graph, with edges representing relationships based on behavioral similarity, temporal adjacency, or shared contextual metadata.
(b) A temporal and behavioral clustering engine that groups transactions into evolving subgraphs based on proximity in time, user activity patterns, transaction categories, and multi-dimensional behavioral features, forming emergent memory paths reflective of habitual or suspicious behavior chains.
(c) A biologically inspired edge-weighting mechanism that incorporates reinforcement for salient or repeated patterns and decay for temporally distant or low-relevance events, mimicking the plasticity of dendritic memory traces in the human brain, allowing prioritization of recent, high-salience behaviors while pruning irrelevant links.
(d) An attention-based recall module that selectively reactivates stored behavioral clusters when new inputs exhibit high contextual similarity, mimicking cognitive memory recall to recognize fraud patterns despite variations in surface-level features.
(e) An anomaly detection and scoring layer that evaluates incoming transactions by computing their deviation from established memory pathways, outputting a dynamic anomaly score based on network disruption, behavioral novelty, or sequence irregularity for real-time flagging and intervention.
(f) An optional quantum computing integration module that enhances performance by simulating entangled transaction states, executing quantum walk-based inference, and enabling parallelized memory traversal across multiple behavioral pathways, accelerating complex pattern recognition in high-volume networks.

This invention unifies biological plausibility, temporal adaptability, and computational scalability, leveraging dendritic spiking-inspired processing, graph-based reasoning, and quantum-compatible structures to outperform static, linear, or shallow-context detection systems, offering real-time learning, high precision, interpretability, and deployment readiness across classical and quantum-compatible hardware.

### DETAILED DESCRIPTION OF THE INVENTION

The Invention, describes a biologically inspired computational system for real-time financial fraud detection. The architecture models memory-like behavior through graph-based representations of transactional data, incorporating temporal dynamics, contextual linkage, adaptive edge weighting, and biologically motivated plasticity mechanisms, with extensibility to quantum computational elements for enhanced performance in large-scale environments.

Each incoming financial transaction is captured via a secure streaming interface (e.g., Apache Kafka) and parsed to extract attributes such as transaction amount, timestamp, user ID, merchant category, device identifier, geolocation, and behavioral biometric patterns (e.g., typing speed, navigation habits). These features are encoded into a multi-dimensional vector
x_i=[x_1, x_2, . . . , x_n], representing a node
v_i in a dynamic memory graph G=(V, E), where (V) is the set of transaction nodes and (E) the set of behavioral edges.

Transactions are analyzed within configurable time windows and grouped into contextual clusters. Edges between nodes v_i and v_j are formed based on behavioral similarity and temporal proximity, using cosine similarity \text {Sim}_{\text {cos}}=\frac {x_i \cdot x_j} {\x_iV/Vx_j\/} and Euclidean distance \text {Dist} _e=\sqrt {\sum (x_{ik}−x_{jk}) \hat{ }2}. An edge is established if the cosine similarity exceeds a threshold \theta_1=0.85 and the temporal difference |t_i−t_j| is less than \theta 2=24 hours.

Each edge e_{ij} in the memory graph is assigned a dynamic weight W_{ij}, which decays exponentially as W(t)=W_0 \cdot e\hat{ }{−\lambda t}, where W_0=1.0, \lambda=0.01, and (t) is the elapsed time since the last activation. A reinforcement mechanism increases weights for recurring patterns as W(n)=W_0 \cdot (1+\alpha \cdot \log (1+n)), where (n) is the recurrence count and \alpha=0.1. This dual mechanism ensures the system retains relevant patterns while pruning obsolete connections, mimicking biological memory dynamics.

An attention-based memory reactivation module, implemented using a transformer-style architecture, monitors new transactions and computes their similarity to historical clusters via scaled dot-product attention: \text {Attention} (Q, K, V)=\text {softmax} \left (\frac {Q K\hat{ }T} {\sqrt {d_k}} \right) V, where (Q) is the current transaction's feature vector, (K) contains vectors from past clusters, (V) stores anomaly-relevant context, and d_kis the dimensionality of (K). This enables recognition of modified fraud patterns by reactivating related memory paths.

Each transaction node v_q receives an anomaly score A(v_q)=\beta_1 (1−text {PathProb})+\beta_2 \text {TemporalDeviation}+\beta_3 (1-\text {ContextSim})+\beta_4 \text {RarityScore}, where \text {PathProb} is the probability of following a known memory path, \text {TemporalDeviation} measures timing divergence, \text {ContextSim} evaluates behavioral similarity, and text {RarityScore} quantifies statistical outliers. Coefficients \beta_1 to \beta_4 are tunable (default: (0.4, 0.3, 0.2, 0.1)) and can be optimized using historical fraud data.

In an advanced embodiment, quantum computing accelerates graph traversal and anomaly detection. Transaction features are encoded into quantum states using amplitude encoding |\psi\rangle=\sum x_i|\rangle. Quantum walks explore the memory graph with enhanced parallelism, quantum interference detects overlapping behavioral patterns, and Grover's algorithm provides quadratic speedup for fraud motif searches, making the system scalable for high-throughput environments.

The Dendritic Spiking Learning Algorithm (DSLA) governs internal learning within memory nodes. Each node functions as a multi-compartment neuron with active dendritic branches, performing localized spiking based on feature-specific inputs. Learning follows spike-timing-dependent plasticity (STDP): if the time difference \Delta t between post-synaptic and pre-synaptic spikes is positive, the weight change is \Delta w=A_+\cdot e\hat{ }{−\Delta t/\tau_+}; if negative, \Delta w=−A_−\cdot e\hat{ }{\Delta t/\tau_−}, with A_+=0.1, A_−=0.05, \tau_+=20, \tau−=20. This enables event-driven learning without backpropagation.

DSLA neurons integrate into the memory graph, with each node activating based on feature coincidence and propagating spikes to neighbors, supporting sparse, asynchronous learning akin to biological neural circuits. These nodes are compatible with neuromorphic hardware and can be extended to the quantum subsystem by encoding dendritic states into entangled quantum registers for hybrid inference.

A visualization and alert interface displays active memory paths (color-coded by risk), node clusters (sized by activity), and temporal evolution via an interactive timeline. High-anomaly nodes are flagged, and alerts include traceable explanation paths derived from attention layers and DSLA spike patterns.

### Examples: Meta-Learning Enhanced Intrusion and Fraud Detection

The implemented model leverages a graph-based neural network combined with a meta-learning framework to enhance intrusion detection in network traffic and fraud detection in financial transactions. For intrusion detection, the CICIDS2017 dataset is used, excluding specific attack types like “DoS GoldenEye” to enable out-of-sample evaluation and ensure generalization to unseen threats. For fraud detection, the IEEE-CIS Fraud Detection dataset is employed, featuring anonymized transactional and identity data, including transaction amounts, device types, and user behavior patterns, with the target variable “isFraud” indicating fraudulent transactions. The model represents network and transactional data as graphs, with nodes encapsulating traffic attributes or transactional details and edges defining interaction patterns (e.g., host communications or transactions from the same device).

The graph-based approach excels in cybersecurity and fraud detection by modeling interactions as graphs. In intrusion detection, nodes represent hosts or traffic events, and edges capture communication patterns; in fraud detection, nodes represent users or transactions, with edges linking related entities (e.g., multiple transactions from the same credit card). The model is initially trained in a supervised manner using cross-entropy loss to classify network events as benign or malicious and transactions as legitimate or fraudulent. Training employs the Adam optimizer, with performance evaluated using recall, precision, F1-score, and ROC-AUC, prioritizing recall to detect attacks while balancing precision to minimize false positives. A pre-trained graph-based model initializes a meta-learning module, enabling rapid adaptation to new attack types and fraud patterns across diverse tasks, enhancing resilience to evolving threats.

The meta-learning phase involves inner and outer optimization loops to enable generalization across intrusion and fraud scenarios. Table 4 presents the meta-learning performance for intrusion detection over epochs 20 to 25, with meta-loss ranging from 1.7546 to 2.0184, indicating stable convergence. Accuracy peaks at 92.77% (Epoch 20) and dips to 86.78% (Epoch 24), while the F1-score, balancing precision and recall, reaches a high of 91.75%, demonstrating robust performance on imbalanced datasets. For fraud detection, ROC-AUC consistently exceeds 0.90, underscoring the model's effectiveness in distinguishing fraudulent transactions with limited samples.

TABLE 4
Meta-Learning Performance, Cyber Intrusion Detection

| Epoch | Meta Loss | Accuracy | F1-Score |
|---|---|---|---|
| 20 | 1.7546 | 0.9277 | 0.9175 |
| 21 | 1.8950 | 0.8810 | 0.8537 |
| 22 | 1.8261 | 0.9088 | 0.8977 |
| 23 | 1.7614 | 0.9148 | 0.9036 |
| 24 | 2.0184 | 0.8678 | 0.8305 |
| 25 | 1.8857 | 0.9064 | 0.8799 |

From a Cyber Intrusion Detection System (IDS) and fraud detection perspective, selecting an optimal architecture requires balancing detection performance, computational efficiency, and real-time adaptability, as defined by the metric prioritization: Recall (Rank 1), Precision (Rank 2), F1-Score (Rank 3), Computational Time (Rank 4), Memory Usage (Rank 5), and Accuracy (Rank 6). Three configurations-Invention Algorithm 1, Invention Algorithm 2, and Invention Algorithm 3—are evaluated, with results aligning with these priorities. Recall is prioritized to minimize missed attacks or fraud, followed by precision to reduce false positives, while computational efficiency ensures suitability for real-time deployment on edge devices or high-throughput systems.

Out-of-bag (OOB) evaluation metrics highlight the trade-offs across the three algorithms. Invention Algorithm 2 and Invention Algorithm 3 achieve superior recall (0.962 and 0.975, respectively), ensuring reliable detection of rare attacks or fraudulent transactions in imbalanced datasets, critical for minimizing financial losses. Their precision scores (0.950 and 0.965, respectively) and F1-scores (~0.97) reflect a balanced performance, effectively reducing false positives while maintaining high detection rates. Invention Algorithm 1, however, exhibits lower precision (0.620) despite a high recall (0.945), leading to a higher false positive rate that may cause alert fatigue in live environments. Its F1-score (0.630) indicates a need for better precision-recall balance to avoid operational inefficiencies.

Resource efficiency analysis reveals significant differences across the algorithms, aligning with the prioritization of computational time (Rank 4) and memory usage (Rank 5). Invention Algorithm 1 demonstrates the highest peak memory usage (3.64 MB during the meta-learning phase) and the longest execution time (7.17 seconds), making it less suitable for edge or latency-sensitive deployments, such as mobile banking or decentralized finance platforms. In contrast, Invention Algorithm 2 and Invention Algorithm 3 are more resource-efficient, with memory usage of 1.50 MB and 1.97 MB, respectively, and faster execution times of 4.82 seconds and 5.15 seconds, respectively. These attributes make them ideal for real-time detection in high-throughput environments, such as payment gateways or cryptocurrency exchanges.

Invention Algorithm 3 emerges as the most balanced solution, offering near-optimal detection metrics with minimal computational overhead. It leverages advanced feature encoding for early anomaly detection, a meta-learning framework for rapid adaptation to novel threats, and dendritic-inspired processing to enhance contextual awareness, addressing the need for zero-day attack and fraud resilience. Invention Algorithm 2, while highly efficient, lacks the same level of adaptability due to its simpler architecture, and Invention Algorithm 1's resource demands outweigh its detection benefits, particularly in resource-constrained settings. The deprioritization of accuracy (Rank 6) ensures focus on more reliable metrics like recall, precision, and F1-score, given the imbalanced nature of the datasets, where accuracy can be misleading due to the predominance of benign transactions.

In conclusion, for high-stakes cybersecurity and fraud detection contexts—where missing an attack or fraudulent transaction is costlier than a false alarm, yet low latency and efficiency are essential—Invention Algorithm 3 provides the best trade-off. It ensures high recall to detect threats, balanced precision to minimize false positives, and efficient resource usage for real-time deployment, making it ideal for intrusion detection and fraud detection systems in banking, fintech, and decentralized finance platforms. This approach enhances resilience against emerging threats and adversarial attacks, supporting rapid adaptation to new attack types and fraud patterns with minimal computational overhead, thereby safeguarding financial ecosystems against evolving risks.

### Advantages

The Invention offers numerous advantages over conventional fraud detection systems by integrating biologically inspired learning, dynamic memory modeling, and scalable computational architectures. First, its adaptability stems from emulating dendritic memory processes, enabling real-time learning and plasticity to autonomously adapt to evolving fraud patterns without manual intervention, unlike static rule-based systems or retraining-dependent models. Second, automatic memory management through biologically plausible edge decay prunes obsolete connections, ensuring computational efficiency while retaining high-salience patterns critical for accurate anomaly detection. Third, the attention-based memory recall mechanism identifies contextually similar past behaviors, capturing nuanced fraud patterns despite surface-level variations. Fourth, the optional quantum computing integration enhances scalability and speed by enabling parallelized graph traversal and pattern matching, overcoming classical algorithm limitations in high-volume environments. Fifth, the graph-based structure supports transparency and explainability, with transaction paths and anomaly scores visualizable and auditable, improving regulatory alignment. Finally, the system offers privacy-preserving deployment options, operating on encrypted or tokenized data at network edges to reduce latency and limit sensitive data movement, making it a robust, adaptive, and secure platform for real-time fraud detection in modern financial ecosystems.

### BRIEF DESCRIPTION OF THE DRAWINGS

The invention will be better understood from the following detailed description, taken in conjunction with the accompanying drawings:

FIG. illustrates the high-level system architecture for real-time fraud detection. The diagram shows the pipeline beginning with transaction ingestion (10), followed by processing through a biologically inspired memory model (12), which interfaces with both the anomaly detection module (14) and an optional quantum integration module (18).

FIG. 2 depicts the process of temporal clustering (16) wherein individual transactions (20) are grouped based on behavioral and temporal proximity. The clustered nodes (18) are then expanded into a full memory graph (10) through edge formation based on behavioral similarity (14), resulting in a network of interconnected transaction nodes (20).

FIG. 3 provides a dual-line graph illustrating memory edge dynamics. The solid curve represents exponential decay over time using the formula W(t)=W0*exp (−λt), while the dashed curve models reinforcement based on behavior repetition using W(n)=W0(1+αlog n). Together, these functions maintain the adaptive plasticity of the memory graph.

FIG. 4 details the attention-based reactivation mechanism. A current transaction (30) draws input from several stored historical patterns (26). These are processed by an attention module (28) to produce contextually relevant output patterns (34), enabling the system to identify recurring fraud motifs even in altered form.

FIG. 5 shows a simplified quantum circuit used in the quantum-integrated memory traversal system. The setup includes a Hadamard gate (H), qubit state initialization (|0), 24), measurement gates (M), and controlled-X operations (26) across quantum channels (22, 28, 30), illustrating quantum walk and interference mechanisms.

FIG. 6 illustrates a use-case deployment model for anti-money laundering (AML). Incoming transaction streams (100) are processed into memory nodes (120), which interface with AML modules (110) and quantum computing integration engines. The system supports anomaly scoring, threshold-based alerts, and real-time notification (140).

FIG. 7 provides a t-SNE clustering visualization of the transaction memory graph. Normal transactions (blue) and fraudulent ones (red) are distinctly clustered. Overlaid annotations describe the dendritic processes: memory formation, update, decay, and reactivation, indicating how biological memory principles are embedded into the fraud detection mechanism.

FIG. 8 compares execution time across three system configurations-Scenario 1 (Dendritic+GraphSAGE+MAML), Scenario 2 (GraphSAGE+MAML), and Scenario 3 (Dendritic+MAML)—across different phases. Scenario 2 exhibits the fastest MAML phase execution time, while Scenario 1 is the most computationally intensive.

FIG. 9 presents the peak memory usage across the same three scenarios. Scenario 1 requires the highest memory during the MAML phase, whereas Scenario 2 and Scenario 3 are more memory-efficient, particularly during inference (OOB) phases.

FIG. 10 displays out-of-bag (OOB) metric comparisons—Accuracy, F1-Score, Recall, MCC, and ROC-AUC—across all scenarios. Scenario 3 (Dendritic+MAML) demonstrates the best balance between performance and efficiency, making it ideal for real-time deployment.

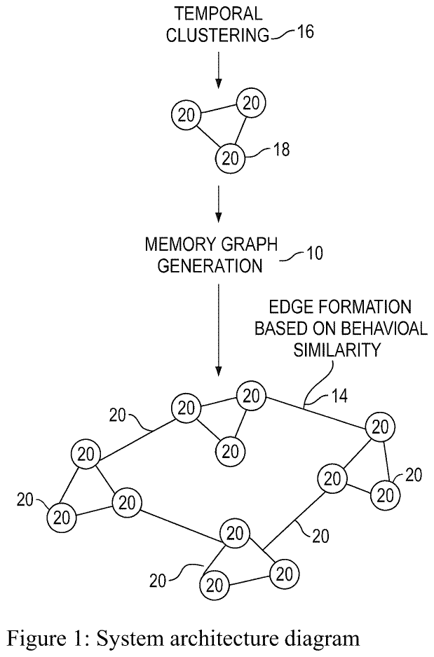

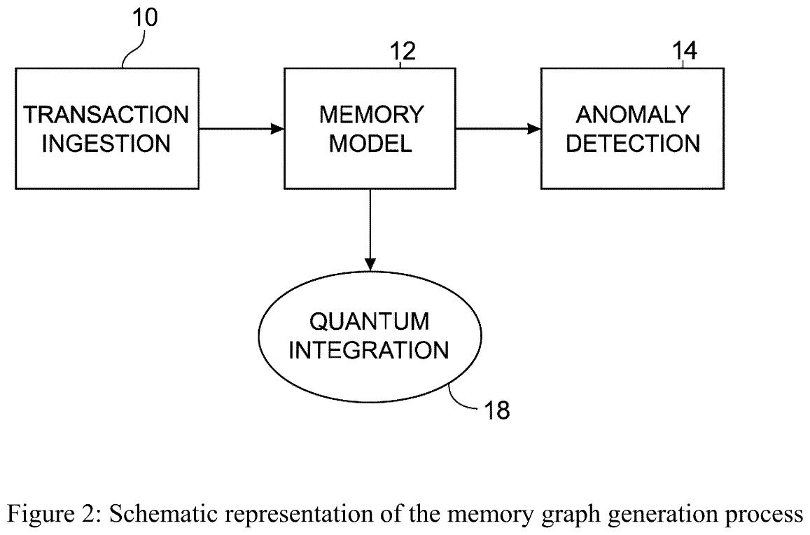

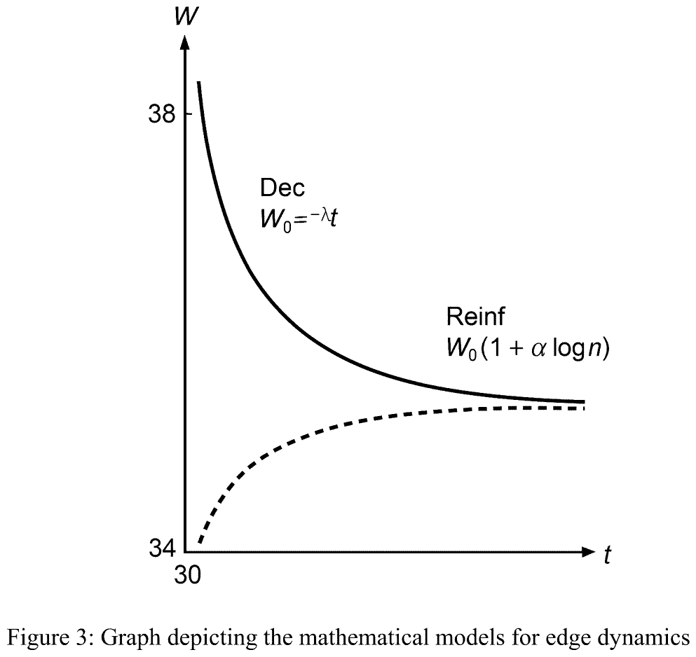

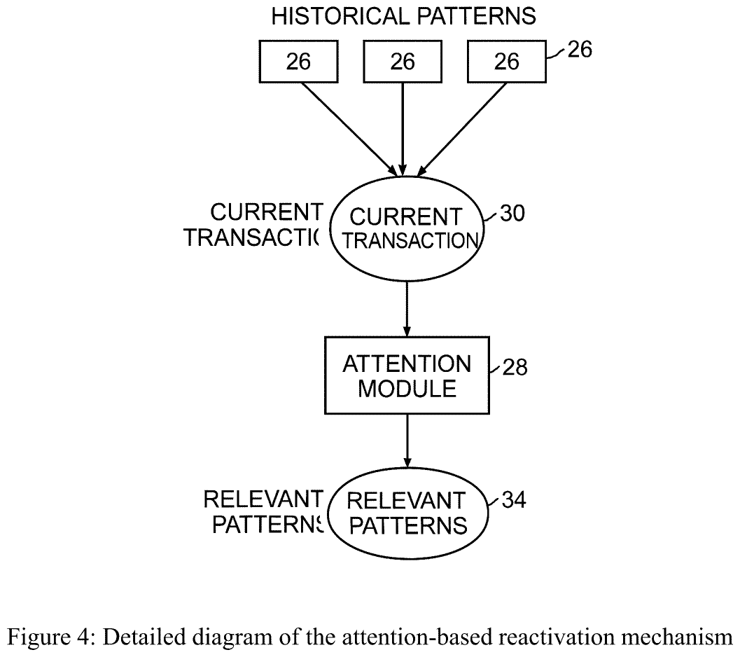

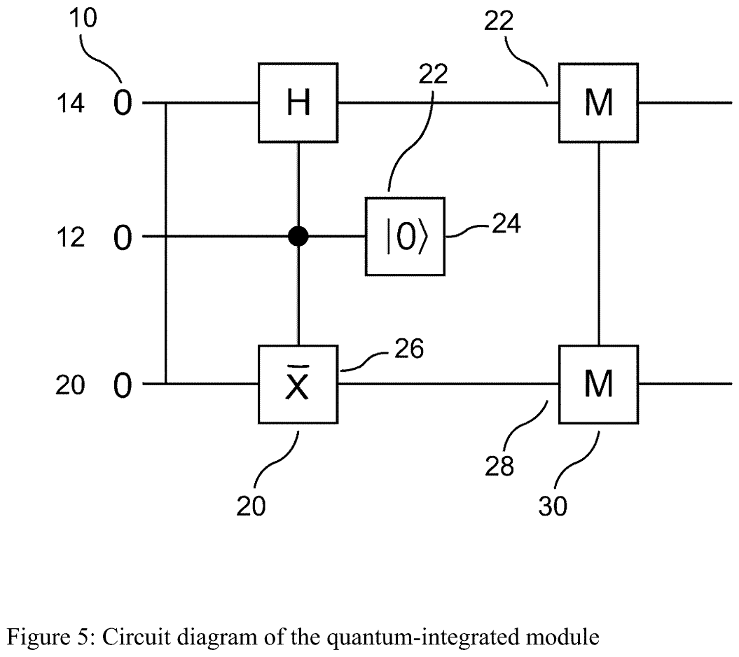

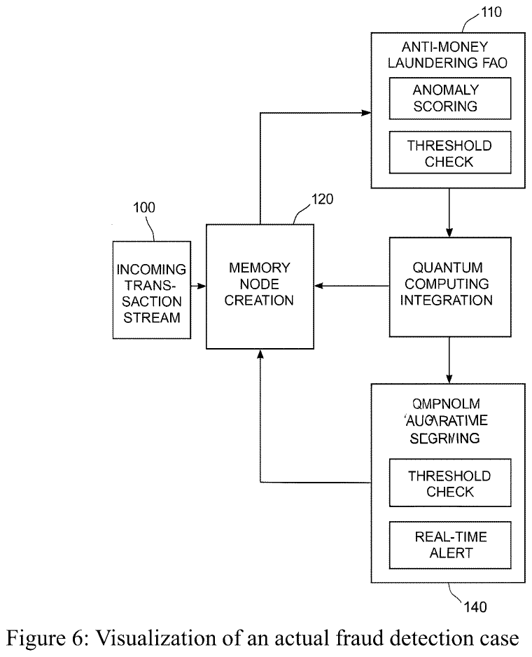

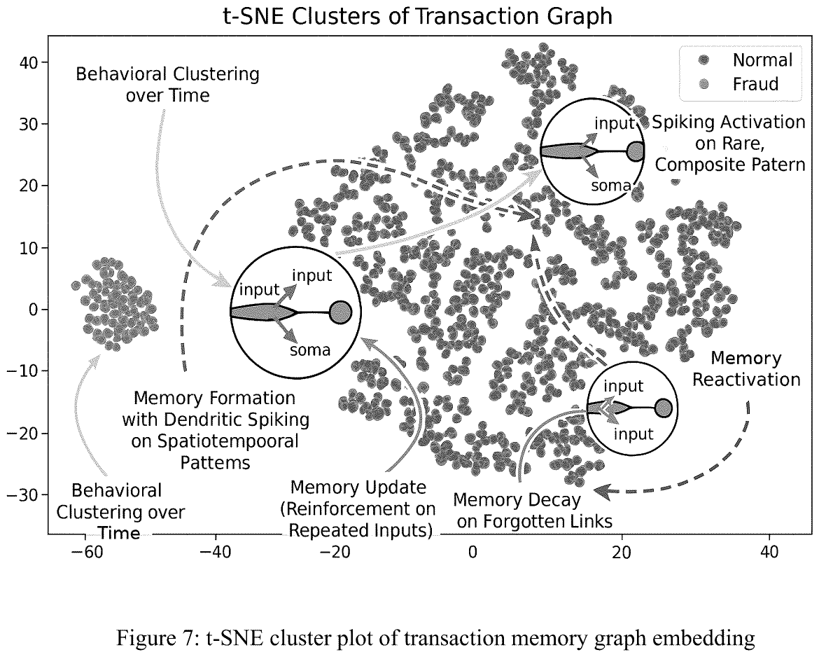

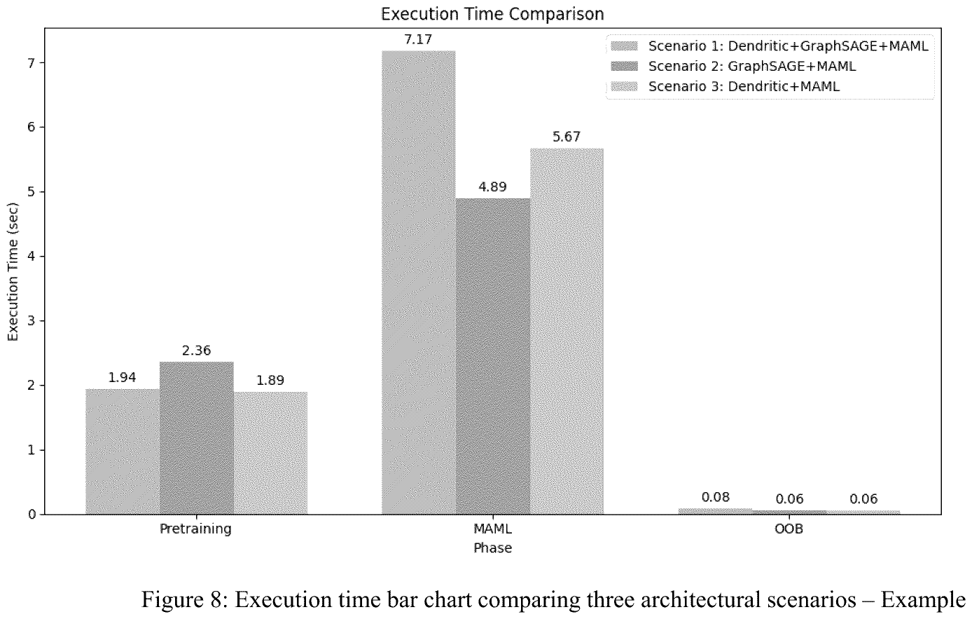

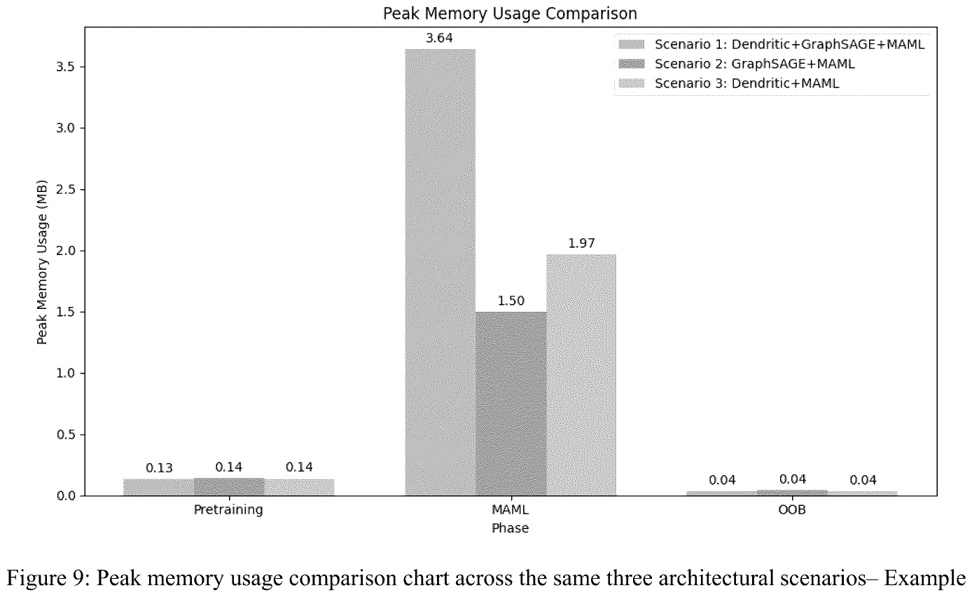

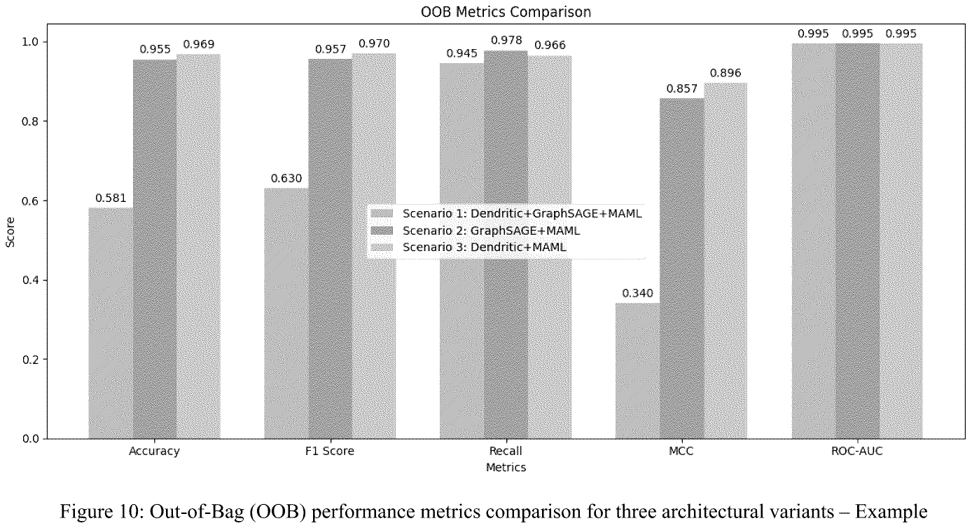

### COMMERCIAL APPLICATIONS

The invention is suitable for implementation in: (a) Banking fraud prevention systems for retail and commercial accounts; (b) Anti-money laundering (AML) compliance systems in regulated financial institutions; (c) Cryptocurrency exchanges and DeFi platforms requiring real-time monitoring; (d) Payment processors and retail payment gateways handling high-volume transactions; (e) Fintech applications with embedded financial services; (f) Insurance claim processing systems to identify fraudulent patterns; and (g) E-commerce platforms aiming to reduce payment fraud and account compromise.

### Implementation Guidance

The system can be implemented using: (a) Transaction data streaming via Apache Kafka or RabbitMQ; (b) Memory graph construction with graph database frameworks like Neo4j or PyTorch Geometric; (c) Edge dynamics implementation using parameterized functions optimized for specific environments; (d) Attention mechanism development with transformer architectures in TensorFlow or PyTorch; (e) Anomaly detection through neural network classifiers trained on labeled fraud data; (f) Quantum modules implemented using Qiskit, Cirq, or cloud-based services like AWS Braket; (g) Visualization with graph libraries such as D3.js or Gephi. The architecture supports both cloud and edge deployment for centralized processing or reduced latency, respectively.

1. A real-time fraud detection system comprising:
a transaction ingestion module configured to receive and preprocess streaming financial transaction data;
a memory model comprising a graph neural network configured to represent each transaction as a node within a dynamically evolving memory graph, wherein edges represent behavioral and temporal similarity;
an edge modulation mechanism that applies biologically inspired decay and reinforcement functions to edge weights, simulating dendritic plasticity;
an attention-based recall module configured to reactivate previously learned memory patterns based on contextual similarity to incoming transactions; and
an anomaly scoring module configured to assign a fraud probability score to each transaction based on deviation from learned memory paths.

2. The system of claim 1, wherein the graph neural network comprises one or more of GraphSAGE, graph attention networks (GAT), or biologically inspired spiking graph architectures.

3. The system of claim 1, wherein the edge modulation mechanism decays edge weights exponentially over time according to a function W(t)=W0·e−λtW(t)=W_0\cdot e\hat{ }{−λt} W(t)=W0·e−λt.

4. The system of claim 1, wherein edge weights are reinforced using a logarithmic function of recurrence frequency W(n)=W0·(1+α·log (1+n))W(n)=W_0\cdot (1+α\cdot \log (1+n))W(n)=W0·(1+α·log(1+n)).

5. The system of claim 1, wherein each transaction node contains features selected from the group consisting of: transaction timestamp, amount, geolocation, device identifier, merchant category, and user behavioral biometrics.

6. The system of claim 1, wherein the attention-based recall module uses scaled dot-product attention to retrieve memory subgraphs relevant to a current transaction.

7. The system of claim 1, wherein the anomaly scoring module computes a weighted sum of path probability, temporal deviation, contextual similarity, and statistical rarity.

8. A computerized method for real-time fraud detection, comprising:
encoding financial transactions as nodes in a temporal memory graph;
forming edges between nodes based on behavioral similarity and temporal proximity;
applying edge weight decay and reinforcement to model forgetting and habit formation;
computing attention-based relevance between new transactions and memory subgraphs; and
assigning an anomaly score to each transaction to indicate potential fraud.

9. The method of claim 8, further comprising clustering transaction nodes within defined time windows using cosine similarity metrics.

10. The method of claim 8, further comprising pruning memory graph edges based on decay threshold criteria.

11. The method of claim 8, further comprising meta-learning from few-shot fraud examples to generalize to novel fraud types.

12. A quantum-classical hybrid system for adaptive fraud detection, comprising:
a classical memory graph constructed from transaction data using dendritic modeling principles;
a quantum walk engine configured to explore the memory graph using amplitude encoding of transaction vectors;
a measurement subsystem configured to extract interference-based fraud motifs from quantum state evolution; and
a hybrid inference module combining classical anomaly scores with quantum-derived fraud probabilities.

13. The system of claim 12, wherein quantum amplitude encoding is applied to transaction feature vectors to initialize quantum states.

14. The system of claim 12, wherein Grover's algorithm is employed to locate specific subgraph patterns associated with known fraudulent activity.

15. The system of claim 12, wherein quantum registers are entangled to represent co-occurring or causally linked transaction events.

16. The system of claim 12, wherein the results of quantum measurements update classical memory graph edge weights through a feedback mechanism.

17. The system of claim 12, wherein quantum interference patterns are interpreted as probabilistic indicators of hidden fraud pathways.

18. The system of claim 1, wherein memory nodes are implemented as dendritic spiking neurons using local spike-timing-dependent plasticity.

19. The system of claim 1, wherein the fraud detection system is deployed on edge devices using neuromorphic processors for low-latency inference.

20. The system of claim 1, wherein the entire memory graph is visualized in real-time, highlighting high-risk clusters based on anomaly scores and dendritic activation paths.
